(19) United States
(12) Patent Application Publication
(10) Pub. No.: US 2011/0298581 A1
(43) Pub. Date: Dec. 8, 2011

(54) UNIVERSAL REMOTE CONTROLLER

(76) Inventor: Wei HSU, Chung Ho City (TW)

(21) Appl. No.: 12/796,416

(22) Filed: Jun. 8, 2010

(51) Int. Cl. G05B 19/02

(52) U.S. Cl. 340/4.3; 340/12.22

(57) ABSTRACT

A universal remote controller comprises a controlling and processing module to control and process the universal remote controller for operating; a storage module coupled to the controlling and processing module and utilized for storing information data, such as remote digital codes of several remote controllable electric devices; a display module coupled to the controlling and processing module and displays an operating interface of the universal remote controller; a finger control module coupled to the controlling and processing module for operating and controlling the universal remote controller; a keypad module coupled to the controlling and processing module for operating and controlling any remote controllable electric device; and a signal transmission module coupled the controlling and processing module to receive a command and emit a controlling signal to the remote controllable electric device for remote controlling.

### FIELD OF THE INVENTION

The present invention relates to a universal remote controller, and more particularly to a universal remote controller utilized to integrate all remote controllable electric devices in a house and further having a joystick device and a friendly interface for operating.

### BACKGROUND OF THE INVENTION

Traditional remote controllers of household electric devices have different specific remote digital codes with the different Brands. Moreover, the different electric devices have the different remote digital codes. Thus, a remote controller of a television can't be utilized to control an air-conditioner, and a remote controller of the air-conditioner can't be utilized to control a DVD player. Therefore, a user needs a lot of remote controllers to control corresponding household electric devices in the house. When he wants to control the television, air-conditioner, or DVD player, he needs to find the remote controller of the television; air-conditioner; and DVD player, respectively. Everyday, he needs to find the remote controllers that he requires from lots of remote controllers. For the user, using various electric devices is to want a more convenient life quality, but finding remote controllers of those electric devices is only to increase his obsession.

Otherwise, because every electric device has its remote controller, a house with three bedroom suite would hold sixteen remote controllers in average. As every remote controller needs two dry batteries per one year for operating, a house would consume thirty two dry batteries in average. Moreover, according to currently research, a dry battery is rotted in the earth such that soil per one square meter loses its worth of farming. Regarding to notions of environmental protection and energy saving, the problems about battery scraps caused by too much remote controllers need to be solved.

In view of the foregoing problems, some manufacturers provide a kind of universal remote controller integrated by various remote controllers of the currently household electric devices. Thus, a user can only use a universal remote controller to control the different electric devices in his house. However, a traditional universal remote controller is utilized a set of codes to represent their corresponding electric devices. That means the user needs to input and lock its code of the electric device in the universal remote controller as using. Moreover, the most persecution to the user is that its code of the electric device needs to set by a code list. Furthermore, when another electric device is used, its code needs to be reset again. Otherwise, the identical Brand may comprise several sets of codes for different household electric devices. Therefore, the traditional universal remote controller not only has complicated setting process but also is inconvenient to search the corresponding electric device. Thus, a predicament is usually occurred that user wants to turn on an electric device but the other is turned on.

In order to solve the above-mentioned problems, some manufacturers provide an improved solution wherein actual keys of the corresponding electric devices are made on an operating panel of the universal remote controller for switching the different electric devices. However, the volume of the improved universal remote controller will be increased due to function keys and switch keys made on the operating panel, and too much keys on the operating panel of the universal remote controller is difficult to identify and operate by a user. Therefore, the improved universal remote control is still inconvenient of operating for a user.

In order to solve the foregoing problems, it needs a universal remote controller which may integrate all remote controllable electric devices, and has a simply operating interface for a user controlling easily. Moreover, the universal remote controller may reduce actual keys on the operating panel for reducing the volume of the universal remote controller.

### SUMMARY OF THE INVENTION

An object of the present invention is to provide a universal remote controller for controlling all remote controllable electric devices in a house.

Another object of the present invention is to provide a universal remote controller which has a simply operating interface for operating easily.

Still another object of the present invention is to provide a universal remote controller which can update its operating interface and various inner settings.

In order to reach above-mentioned object, the present invention provides a universal remote controller, comprising: a controlling and processing module to control and process the universal remote controller for operating; a storage module coupled to the controlling and processing module for storing information data, wherein the information data comprises a plurality of remote digital codes of remote controllable electric devices; a display module coupled to the controlling and processing module for displaying an operating interface of the universal remote controller; a finger control module coupled to the controlling and processing module for inputting a first command to the controlling and processing module for controlling the universal remote controller; an keypad module coupled to the controlling and processing module for inputting a second command to the controlling and processing module for controlling any one of the remote controllable electric device; and a signal transmission module coupled to the controlling and processing module for receiving the first command and the second command from the controlling and processing module and emitting a controlling signal to control the remote controllable electric device.

In order to reach above-mentioned another object, the present invention provides an universal remote controller, comprising: a power switch button disposed on an operating panel of the universal remote controller for turning on or off the universal remote controller; a display screen disposed on the operating panel of the universal remote controller and below the power switch button for displaying an operating interface of the universal remote controller; a plurality of channel control buttons disposed below the display screen for monitoring channels of any remote controllable electric device; a plurality of volume control buttons disposed adjacent to the channel control buttons for monitoring volume of the remote controllable electric device; and a joystick disposed on the remote controller for controlling the operating interface displayed on the display screen.

In order to reach above-mentioned still object, the present invention provides an universal remote controller, comprising: a controlling and processing module to control and process the universal remote controller; a display screen coupled to the controlling and processing module for displaying an operating interface of the universal remote controller; a storage module coupled to the controlling and processing module for storing the operating interface and a plurality of remote digital codes of remote controllable electric device; a joystick coupled to the controlling and processing module for controlling the operating interface; a plurality of buttons coupled to the controlling and processing module for remote controlling any remote controllable electric device; and a signal transmission module coupled to the controlling and processing module for receiving a command from the controlling and processing module and emitting a controlling signal to the remote controllable electric device for remote controlling. The universal remote controller further includes a connecting port to couple a computer for updating data. Moreover, the universal remote controller can copy and store all functions of key on the remote controller of any remote controllable electric device. Otherwise, a user can use the universal remote controller to aim the remote controllable electric device he want to control for obtaining the remote controlling frequency of the remote controllable electric device through automatic searching of the universal remote controller.

In one embodiment of the present invention, the remote digital codes of remote controllable electric devices can be obtained by cell phones through an internet network. Sequentially, the remote digital codes can be transferred to the universal remote controller of the present invention by the cell phones through a transmission mode, such as Bluetooth. Thus, the universal remote controller can be used to remote control the remote controllable electric devices.

In another embodiment of the present invention, the keypad module of the universal remote controller further comprises a set of actual input keypad. Users can use the set of actual input keypad to edit and control all functions in the operating interface of the universal remote controller or an interface of the remote controllable electric device more conveniently. In still another embodiment of the present invention, the display module of the universal remote controller further comprise a touch panel, and the operating interface further comprises a set of virtual input keypad interface. Users can use the set of virtual input keypad interface to edit and control all functions in the operating interface of the universal remote controller or an interface of the remote controllable electric device more conveniently.

A detailed description is given in the following embodiments and with reference to the accompanying drawings and claims.

### BRIEF DESCRIPTION OF THE DRAWINGS

FIG. 1 shows a block diagram of a universal remote controller according to the present invention.

FIG. 2 shows a stereo view diagram of an embodiment of a universal remote controller according to the present invention.

FIG. 3 shows a side view diagram of the embodiment of the universal remote controller according to the present invention.

FIG. 4 shows an illustration of another embodiment of a universal remote controller according to the present invention.

FIG. 5 shows a diagram of a main menu of an operating interface of the universal remote controller of the embodiment according to the present invention.

FIGS. 6A-6E show diagrams of operating interfaces corresponding to various remote controllable electric devices of the universal remote controller of the embodiment according to the present invention.

FIG. 7 shows a diagram of controlling method of these various remote controllable electric devices by the universal remote controller of the embodiment according to the present invention through a center controlling system.

FIG. 8A shows a diagram of updating method of the embodiment of the universal remote controller via internet network by coupling to a computer.

FIG. 8B shows a diagram of a method of copying all buttons of a remote controller of a remote controllable electric device by the embodiment of the universal remote controller according to the present invention.

FIG. 8C shows a diagram of a method of searching remote frequency of a remote controllable electric device by the embodiment of the universal remote controller according to the present invention.

FIG. 9 shows a flow chart of a method for the universal remote controller of the present invention to obtain remote digital codes of a remote controllable electric device by a cell phone.

### DETAILED DESCRIPTION OF THE PREFERRED EMBODIMENT

The invention hereinafter will be described in greater detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended Claims.

The present invention and embodiments now are described in detail. In diagrams and descriptions as below, the same symbols are utilized to represent the same or similar elements. The main of features of the embodiments of the present invention are described in highly simplified illustration. Otherwise, the drawings of the present invention do not depict every characteristic of the actuality embodiments, and all elements of the drawings are not depicted in proportional size but in relative size.

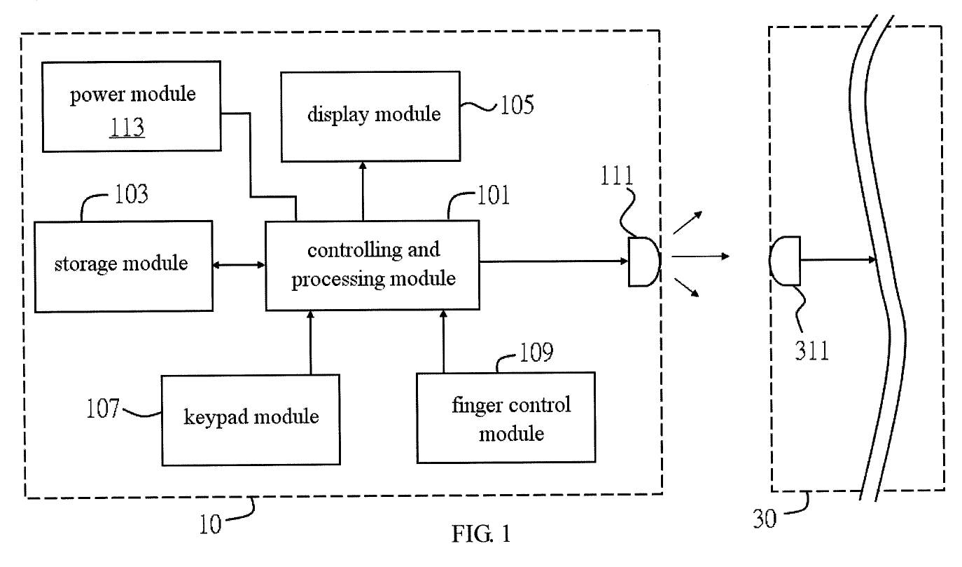

FIG. 1 shows a block diagram of a universal remote controller of the present invention. In order to illustrate more clearly mainly characteristics of the present invention, partly circumstantial elements of the universal remote controller of the embodiment according to the present invention are omitted from the drawings. In FIG. 1, a universal remote controller 10 comprises a controlling and processing module 101, a storage module 103, a display module 105, a keypad module 107, a finger control module 109, a signal transmission module 111, and a power module 113. Furthermore, the signal transmission module 111 of the universal remote controller 10 corresponds to a signal transmission module 311 of any remote controllable electric device 30 for remote controlling the remote controllable electric device 30.

The controlling and processing module 101 is utilized to control and process the operation of the universal remote controller 10. The controlling and processing module 101 comprises a micro-processor, but not limited to this. The storage module 103 is coupled to the controlling and processing module 101 for storing various information data of the universal remote controller 10. The information data comprises remote digital codes of various electric devices and various operating interface data. Moreover, the storage module 103 comprises memory. The display module 105 is coupled to the controlling and processing module 101 for displaying the operating interface of the universal remote controller 10. The operating interface of the universal remote controller 10 comprises a graphic user interface (GUI) which can be modified depending on a user's demand by the controlling and processing module 101, and thereby storing the modified data in the storage module 103 for customizing the interface. The display module 105 comprises a liquid crystal display.

Furthermore, the keypad module 107 and the finger control module 109 are utilized to input an instruction for operating the universal remote controller 10 for a user. The keypad module 107 further comprises a power switch button, a shortcut button, a channel control button, a volume control button, and a return button for a user to control various remote controllable electric devices 30 quickly by the universal remote controller. The finger control module 109 comprises a joystick, a directional pad, or a trackball etc., but not limited to this. A user can use his fingers to operate the finger control module 109 for controlling the operating interface shown on the display module 105 to control or set the universal remote controller 10. Moreover, the universal remote controller 10 further comprises a signal transmission module 111 for emitting a controlling signal to a signal receiving module 311 of any remote controllable electric device 30. The remote controlling signal is outputted from the controlling and processing module 101 by a user controlling the keypad module 107 or the finger control module 109. Thus, the user can use the universal remote controller 10 to control any remote controllable electric device in his house. The signal transmission module 111 and the signal transmission module 311 can be emitted and received by infrared ray, Bluetooth, Wi-Fi, or the combination thereof. The remote controllable electric device 30 comprises any remote controllable household electric device, such as a computer, a television, an air-conditioner, an audio equipment, a DVD player, a game console, a set-top box, a projector, a microwave oven, a refrigerator, an electric roller shutter, and so on, but not limited to those.

For example, the finger control module 109 is a joystick, which comprises at least one set of joystick potentiometer coupled to the controlling and processing module 101. When a user operates the joystick with his finger, the at least one set of joystick potentiometer will output two sets of voltages respecting X-axis and Y-axis respectively according to the input position to the controlling and processing module 101. The controlling and processing module 101 reads the voltage data by an analogy-to-digital converter (ADC) to confirm the position of the joystick for achieving movement and orientation functions according to the command signals.

An operating method of the universal remote controller 10 according to the present invention is described in detail. A user can use a power switch button of the keypad module 107 to turn on the universal remote controller 10. When the universal remote controller 10 is turned on, the display module 105 will display an operating interface of the universal remote controller 10 for the user. Then, the user can control the operating interface displayed on the display module 105 by the finger control module 109, and therefore the user can select a remote controllable electric device, for example a television, a DVD player, an air-conditioner, an audio equipment, or a game console etc. When the user selects the remote controllable electric device that he wants to control through the finger control module 109, the operating interface displayed in the display module 105 would be transfer to an exclusive operating interface of the remote controllable electric device. Then, the user can press the power switch button again to turn on the remote controllable electric device, and operates the finger control module 109 to remote control the remote controllable electric device through the exclusive operating interface displayed on the display module 105. Moreover, the user also can use those shortcut buttons, channel control buttons, and volume control buttons of the keypad module 107 to remote control the remote controllable electric device quickly. When the user wants to change the electric device to remote control, he only presses the return button of the keypad module 107 or uses the finger control module 109 to operate a return key in the operating interface displayed on the display module 105 to return the main menu of the operating interface of the universal remote controller 10 for selecting the other remote controllable electric devices. Otherwise, the keypad module 107 comprises a plurality of shortcut buttons for providing a user to set the shortcut buttons corresponding to some specific remote controllable electric devices, and the user can use the shortcut buttons to enter the exclusive operating interface of the corresponding remote controllable electric devices quickly.

The power module 113 is utilized to supply power to the universal remote controller 10. Depending on different designs of the universal remote controller 10 comprise recharge batteries or dry batteries, but not limits in these.

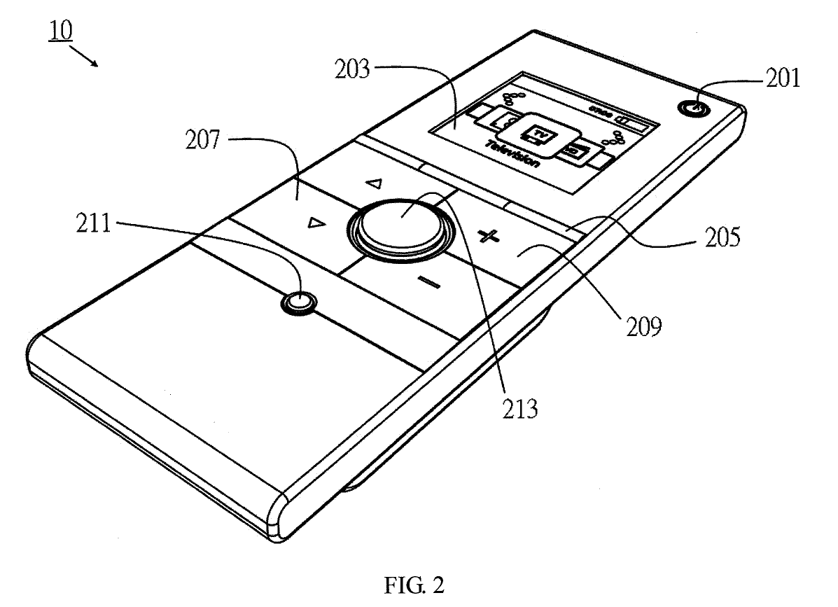

FIG. 2 shows a stereo view of the embodiment of the universal remote controller 10 according to the present invention. The universal remote controller 10 has a controlling panel, which has a power switch button 201, a display screen 203, a plurality of shortcut buttons 205, two channel control buttons 207, two volume control buttons 209, a return button 211 and a joystick 213. A user can use the power switch button 201 to turn on the universal remote controller 10. In this embodiment, a user may press the power switch key 201 about three seconds to turn on the universal remote controller 10, and the display screen 203 would display an operating interface. Similarly, when the user presses the power switch button 201 about three seconds again, the universal remote controller 10 would be turned off. In this embodiment, the universal remote controller 10 would be inputted any instruction exceeding ten seconds after turning on, and the universal remote controller 10 would enter to a standby mode for saving power.

The channel control buttons 207 comprises a previous channel button and a next channel button, and the previous channel button and the next channel button would be utilized to the different functions in the different exclusive operating interface according to the different household electric devices. The volume control buttons 209 comprises a high volume button. Similar with the channel control keys 207, and the high volume button and the low volume button would be utilized to the different functions in the different exclusive operating interface according to the different household electric devices.

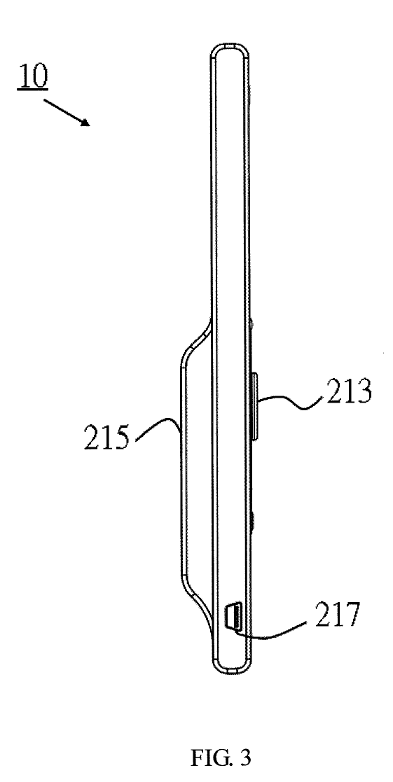

FIG. 3 shows a side view of the embodiment of the universal remote controller 10 according to the present invention. The universal remote controller 10 comprises a battery placing area 215 for placing batteries. In the embodiment, the battery used in the universal remote controller 10 comprises dry batteries or recharge batteries. Moreover, the universal remote controller 10 comprises a connecting port 217 for coupling to an information processing device, for example, a computer. In the embodiment, the connecting port 217 comprises a mini-USB port. A user can use a mini USB-to-USB cable to connect the universal remote controller 10 and a computer for transferring information data. When the universal remote controller 10 uses the recharge battery, the user can use the connecting port 217 to couple to a power source for charging the recharge battery in the universal remote controller 10.

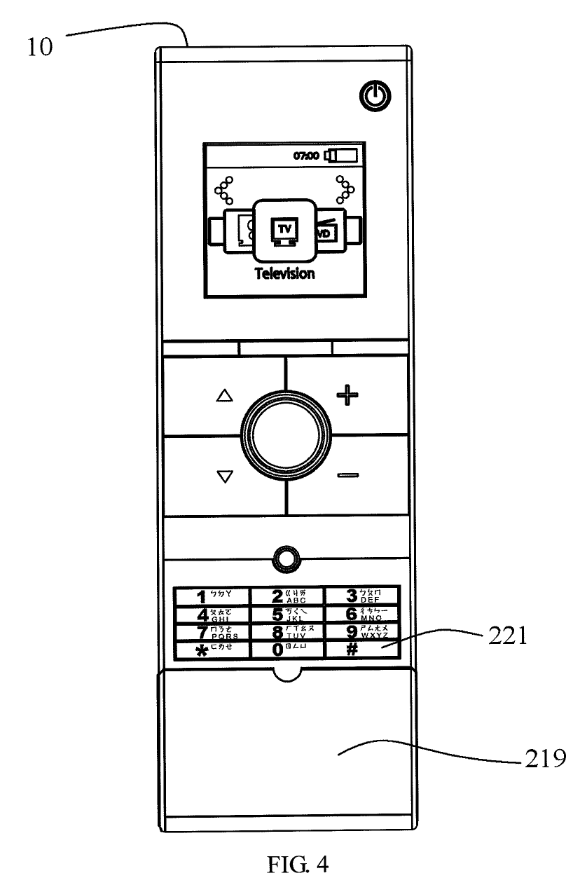

FIG. 4 shows another embodiment of a universal remote controller according to the present invention. In this embodiment, the universal remote controller 10 further comprises a cover 219 and a set of actual input keypad 221. The cover 219 can be utilized to cover the set of actual input keypad 221. A user can remove the cover 219 when he wants to use the set of actual input keypad 221. The cover 219 can be connected to the universal remote controller 10 with several tracks, and the set of actual input keypad 221 can be appeared by down sliding the cover 219 with these tracks when a user wants to use the set of actual input keypad 221. Thus, a user only needs to up slide the cover 221 with these tracks to cover the set of actual input keypad 221 for keeping the volume of the universal remote controller 10. It's noted to that the connection of the cover 219 and the universal remote controller 10 with several tracks only uses to illustrate, but not to limit the scope of the present invention. The connection of the cover 219 and the universal remote controller 10 can use any connections of the traditional technology to approach.

In still another embodiment, the display module further comprises a touch panel, and the operating interface comprises a set of virtual input keypad interface. A user can use the set of virtual input keypad interface to input editor of the operating interface of the universal remote controller or the interface of the remote controllable electric device quickly.

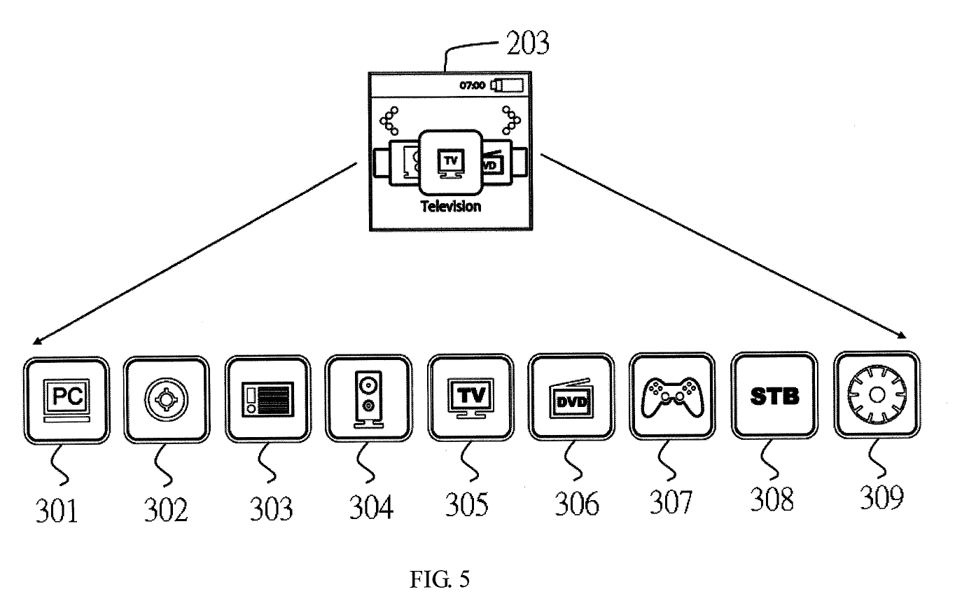

Now, illustrations of the operating interface of the universal remote controller 10 according to the present invention are provided. Regarding to FIG. 5, it shows a main menu of the operating interface displayed on the display screen 203 when a user turns on the universal remote controller 10. In this embodiment, the operating interface comprises a GUI for a user identifying electric device he wants to control by choosing graphs, but not limited in this. In this embodiment, graphs of the main menu of the universal remote controller 10 may be selected, for example, a computer graph 301, a projector graph 302, an air-conditioner graph 303, an audio equipment graph 304, a television graph 305, a DVD player graph 306, a game console graph 307, a set-top box graph 308, and setting graph 309 etc., to choose a remote controllable electric device that he wants to control. These graphs shown in this is only utilized to illustrate the embodiment according to the present invention, but not to limit the scope of the present invention. The main menu of the operating interface further comprises some information such as current time and current electric power. In this embodiment, a user can operate the joystick 213 in right or left direction movement by his finger to show a graph of the main menu on the display screen 203, and the user can press the joystick 213 for confirming his commands.

In order to illustrate the characteristics of the operating interface of this embodiment according to the present invention more clearly, several examples are used here to explain. First of all, when a user operates the joystick 213 in right or left direction movement, the graphs in the main menu displayed on the display screen 203 will move in right or left direction according to the joystick 213. When the user selects a graph of a remote controllable electric device that he wants to control, for example a television, and presses the joystick 213 for confirming. Then, the display screen 203 of the universal remote controller 10 will show the exclusive operating interface of the television.

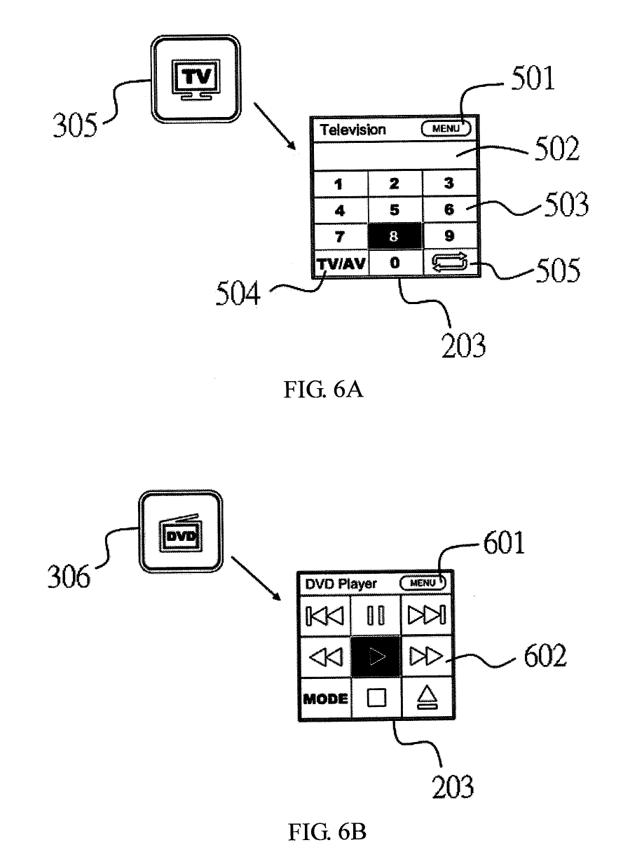

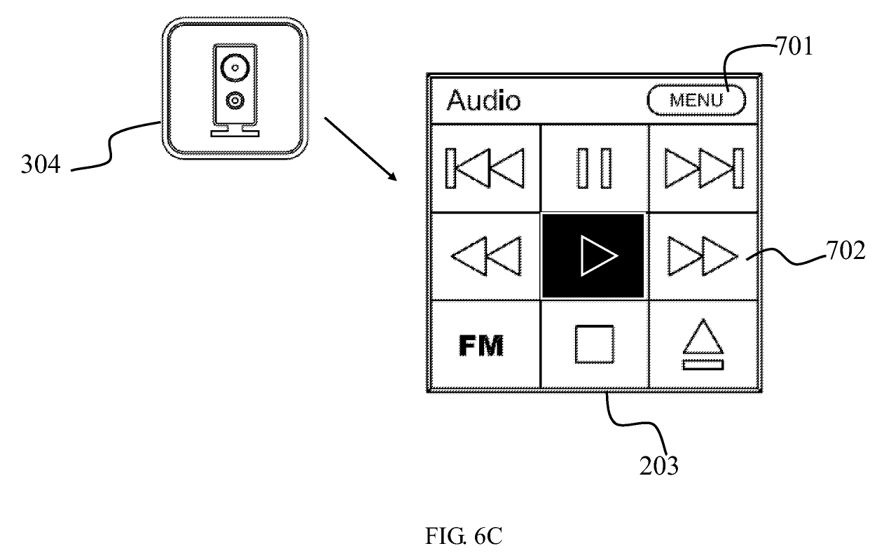

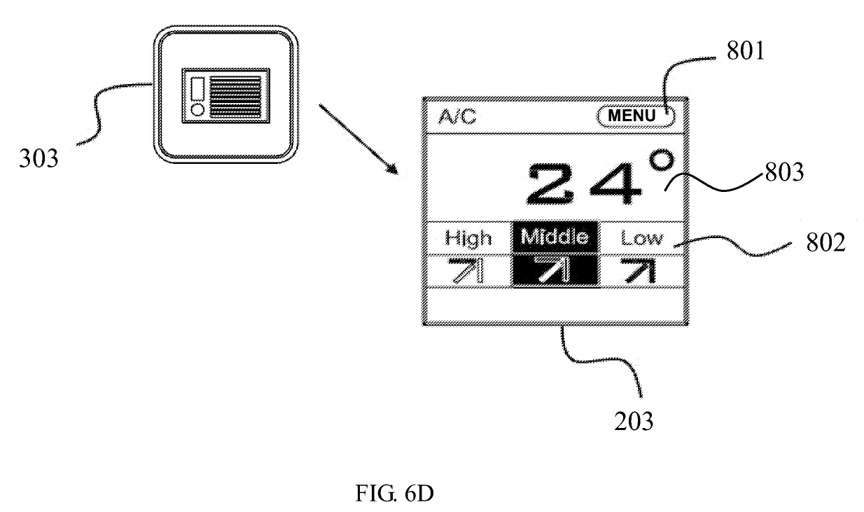

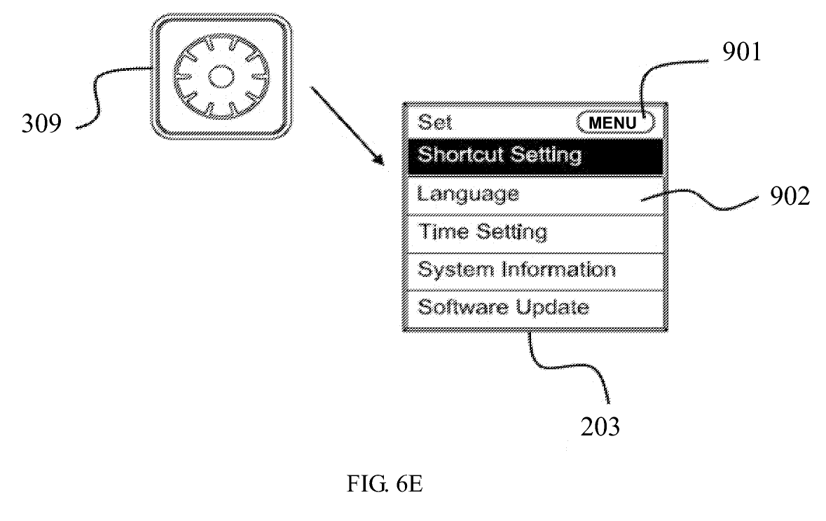

In FIG. 6A, when the user selects the graph of the television 305, the display screen 203 will show the operating interface of the television. A sign “television” will show on the top-left of the display screen 203 of the universal remote controller 10 for the user to confirm that the current operating interface is corresponding to the television. Moreover, the operating interface of the television further comprises an advanced menu 501, an input display region 502, a plurality of number buttons 503, a TV/AV mode switching button 504 and a return button 505. The advanced menu 501 of the television is utilized to control the detail functions of the television, such as contrast and brightness etc. In this embodiment, none of actual number buttons are designed on the universal remote controller 10, and therefore reducing the actual buttons of the universal remote controller 10. Because the number buttons are really not required to some remote controllable electric devices, using virtual number buttons in the exclusive operating interface displayed on the display screen 203 to reduce actual buttons on the universal remote controller 10 is more convenient to operate for users. The “0-9” number buttons 503 of the operating interface of the television will be shown on the display screen 203, and the user can operate the joystick 213 up, down, right or left direction movement to select a number that he wants. When the number is selected, the user presses the joystick 213 for confirming the command and the input display region 502 will show the selected number. For example, when the user operates the joystick 213 to control the anti-white block to select and confirm the number “05”, the number “05” will be shown on the input display region 502. Then, the channel of the television will be transferred to the fifth channel according to the input command from the user. Furthermore, the function of the TV/AV mode switching button 504 is the same function according to a traditional remote controller of the television, and the user only operates the joystick 213 to move the anti-white block to the TV/AV mode switching button 504 displayed on the display screen 203 and presses the joystick 213 for confirming. Then, the television would transfer its TV mode to AV mode, and vice versa.

When the graph of the television 305 is selected from the main menu of the universal remote controller 10, the exclusive operating interface of the television is shown. Then, the user only presses the actual power switch button 201, and the television will be turned on. Similarly, the television will be turned off when the user presses the actual power switch button 201 again. When the user presses the actual channel control button 207, the channel of the television will be changed depending on the user's controlling. Moreover, when the user presses the actual volume control buttons 209, the volume of the television will be monitored by the user with the high volume button and the low volume button. The user also can operate the joystick 213 to move the anti-white block of the operating interface to the position of the return button 505, or press the return button 211 of the actual buttons to let the operating interface of the universal remote controller 10 returning to the main menu. It's needed to understand that the operating interface is utilized to illustrate the present invention, but not limited to this.

Regarding to FIG. 6B, when the user selects a graph of DVD player 306 from the main menu, the exclusive operating interface of the DVD player will be shown on the display screen 203. Similarly, a sign “DVD player” will show on the top-left of the display screen 203 of the universal remote controller 10 for the user to confirm that the current operating interface is corresponding to the DVD player. Moreover, the operating interface of the DVD player further comprises an advanced menu of the DVD player 601 and a function menu of the DVD player 602. The advanced menu of the DVD player 601 is utilized to control the detail selection functions of the DVD player, such as language setting of the DVD player, the display aspect ratio setting etc. The function menu of the DVD player 602 further comprises a play button, a pause button, a previous button, a next button, a fast forward button, a backward button, a stop button, a mode selection button, and an exit button for the user to control the DVD player. Similarly, the user operates the joystick 213 up, down, right, or left direction to move the anti-white block of the operating interface displayed on the display screen 203, and the DVD player will be operated by the user controlling. When the DVD player graph is selected from the main menu of the universal remote controller 10, the exclusive operating interface of the DVD player is shown. Then, the user only presses the actual power switch button 201, and the DVD player will be turned on. Similarly, the DVD player will be turned off when the user presses the actual power switch button 201 again. When the user presses actual channel control button 207, the playing item will be changed depending on the user's controlling. Moreover, when the user presses the actual volume control buttons 209, the volume of the DVD player will be monitored by the user with the high volume button and the low volume button. The user also can press the return button 211 to let the operating interface of the universal remote controller 10 returning to the main menu. It's needed to understand that the operating interface is utilized to illustrate the present invention, but not limited to this.

Regarding to FIG. 6C, when the user selects a graph of audio equipment 304 from the main menu, an exclusive operating interface of the audio equipment will be shown on the display screen 203. Similarly, a sign “Audio” will show on the top-left of the display screen 203 of the universal remote controller 10 for the user to confirm that the current operating interface is corresponding to the audio equipment. Moreover, the operating interface of the audio equipment further comprises an advanced menu of the audio equipment 701 and a function menu of the audio equipment 702. The advanced menu of the audio equipment 701 is utilized to control the detail function of the audio equipment, such as input setting, playing setting, and speaker setting etc. The function menu of the audio equipment 702 further comprises a play button, a pause button, a previous button, a next button, a fast forward button, a backward button, a FM broadcast button, and an exit button for the user controlling. Similarly, the user operates the joystick 213 up, down, right, or left direction to move the anti-white block of the operating interface displayed on the display screen 203, and the audio equipment will be operated depending on the user controlling. When the graph of audio equipment 304 is selected from the main menu of the universal remote controller 10, the exclusive operating interface of the audio equipment is shown. Then, the user only presses the actual power switch button 201, and the audio equipment will be turned on. Similarly, the audio equipment will be turned off when the user presses the actual power switch button 201 again. When the user presses actual channel control buttons 207, the playing item will be changed depending on the user's controlling. Moreover, when the user presses the actual volume control buttons 209, the volume of the audio equipment will be monitored by the user with the high volume button and the low volume button. The user can press the return button 211 to let the operating interface of the universal remote controller 10 returning to the main menu. It's needed to understand that the operating interface is utilized to illustrate the present invention, but not limited to this.

Regarding to FIG. 6D, when the user selects a graph of air-conditioner 303 from the main menu, an exclusive operating interface of the air-conditioner will be shown on the display screen. Similarly, a sign “A/C” will show on the top-left of the display screen 203 of the universal remote controller 10 for the user to confirm that the current operating interface is corresponding to the air-conditioner. Moreover, the operating interface of the air-conditioner further comprises an advanced menu of the air-conditioner 801, a wind velocity selecting menu of the air-conditioner 802, and a temperature displaying region 803. The advanced menu of the air-conditioner 801 is utilized to control the detail function of the air-conditioner, such as sleeping setting, and humidity setting etc. The wind velocity selecting menu of the air-conditioner 802 further comprises three selections as a high button, a middle button, and a low button for the user controlling. The temperature display region 803 is utilized to show the temperature value that the user wants to. Similarly, the user operates the joystick 213 up, down, right, or left direction to move the anti-white block of the operating interface displayed on the display screen 203, and the air-conditioner will be operated depending on the user controlling. When the graph of air-conditioner 303 is selected from the main menu of the universal remote controller 10, the exclusive operating interface of the air-conditioner is shown. Then, the user only presses the actual power switch button 201, and the air-conditioner will be turned on. Similarly, the air-conditioner will be turned off when the user presses the actual power switch button 201 again. The channel control buttons 207 in the exclusive operating interface of the air-conditioner is utilized to monitor wind strengths of the air-conditioner, and the volume control buttons 209 is utilized to monitor the temperature value of the air-conditioner. The user can monitor the temperature value with the volume control buttons 209 depending on the temperature value shown on the temperature displaying region 803. It's needed to understand that the operating interface is utilized to illustrate the present invention, but not limited to this. The present invention only provides four exclusive operating interfaces according to four different electric devices for illustrating, however, one person skilled in the art can be easy to obtain further exclusive operating interfaces of the others electric devices depending on the above-mentioned descriptions of the present invention. There detailed description is omitted.

Finally, a setting operating interface of the universal remote controller 10 according to the present invention is illustrated. Regarding to FIG. 6E, when the user selects a setting menu 309 from the main menu, an exclusive setting operating interface will be shown on the display screen 203. The setting operating interface further comprises an advanced setting menu 901 and a setting menu 902 of the universal remote controller. The advanced setting menu 901 is utilized to set the detail function of the universal remote controller 10, such as brightness of the display screen or modifications of the user interface. The setting menu 902 further comprises several selections, such as shortcut setting, language, time setting, system information, and software update for the user selecting. The selection of shortcut setting is utilized for the user to set the functions of the plurality of shortcut buttons 205 of the universal remote controller 10. For example, the user can only press one of the shortcut buttons 205, and the universal remote controller 10 will show an exclusive operating interface of the electric device that the user prefers to. In this embodiment, the shortcut buttons 205 comprise three buttons for the user setting, but not limited to this. The selection of the language is utilized for the user to set language of the operating interface displayed on the display screen 203 of the universal remote controller 10. That means that the user can change his acquainted language to operate the universal remote controller 10. The selection of time setting is utilized for the user to set or modify the current time shown on the display screen 203. The selection of the system information is utilized to show the current information version of the operating interface of the universal remote controller 10 for the user. Moreover, the user can cancel some exclusive operating interfaces of electric devices absent in his house or out of use, or add some exclusive operating interface absent in the universal remote controller 10 for customizing.

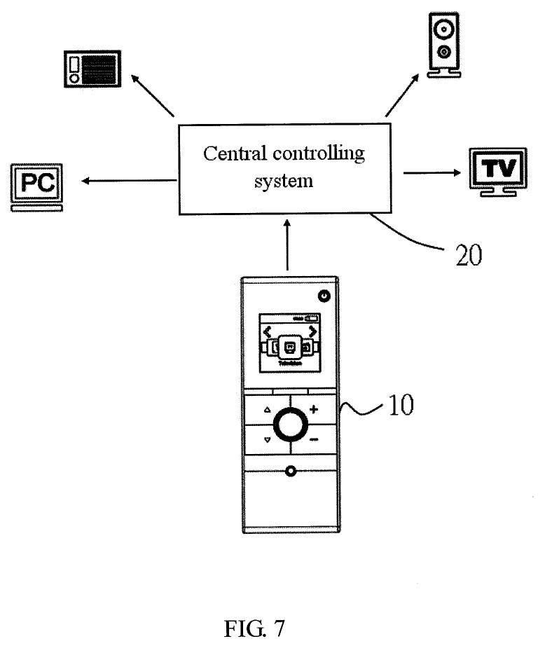

Now, a method of using the universal remote controller 10 of the present invention to control various household electric devices is provided. Regarding to FIG. 7, it shows an embodiment according to the present invention which is a system of a smart home. All remote controllable electric devices in a house can be controlled by the universal remote controller 10 through a center controlling system 20. In this embodiment, a command signal is emitted from the signal transmission module 111 of the universal remote controller 10 into the center controlling system 20. When the center controlling system 20 receives the command signal from the universal remote controller 10, a remote controllable electric device corresponding to the command signal would be operated. In FIG. 7, it only illustrates four household electric devices, but one person skilled in the art can easy to understand household electric devices remote controlled by the center controlling system 20 and the universal remote controller 10 according to the present invention do not be limited to these four household electric devices.

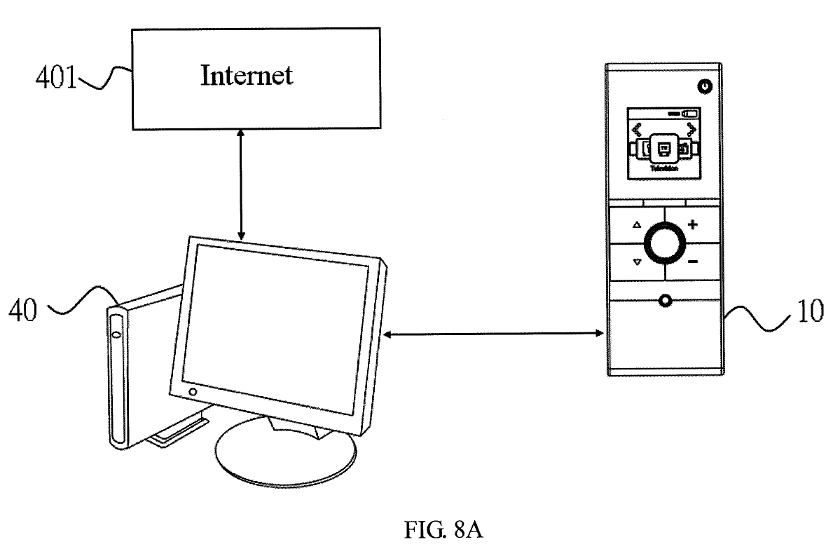

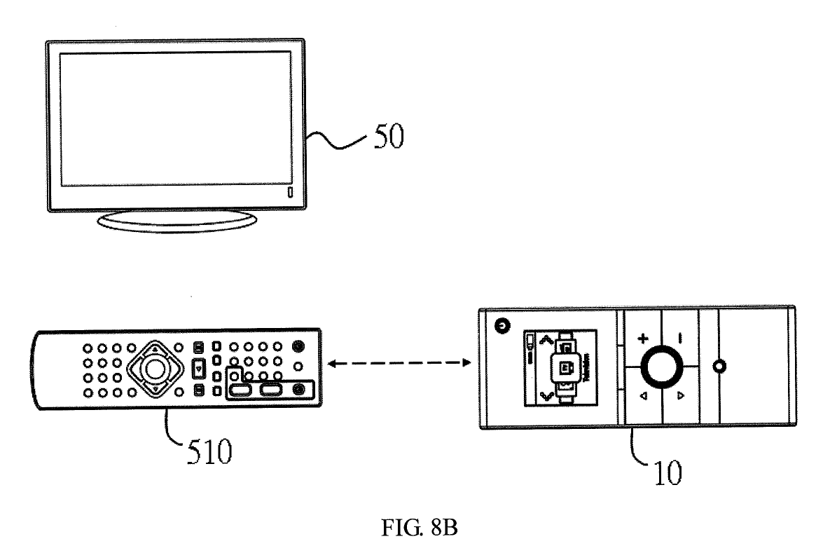

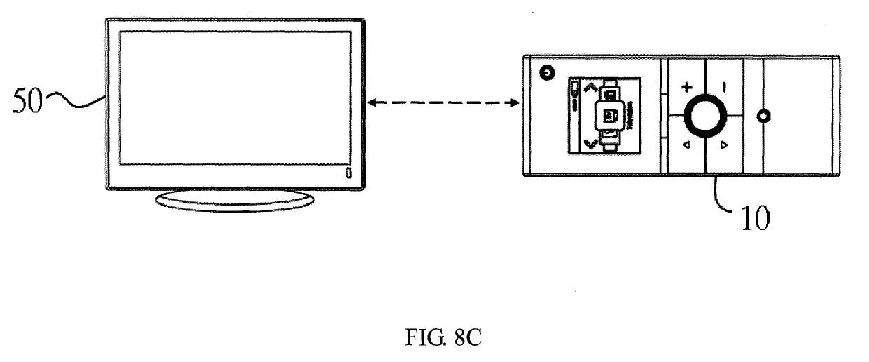

Regarding to FIG. 8A, it shows another embodiment of the present invention. In this embodiment, the universal remote controller 10 can couple to a computer 40 to download all of remote digital codes of the remote controllable electric devices in the house through an internet network 401 and store these information data in the storage module 103 of the universal remote controller 10. Then, a user can use the universal remote controller 10 to control all the remote controllable electric devices in the house. In this embodiment, the universal remote controller 10 can couple to the computer 40 with a mini USB-to-USB connector for transferring information data. In some embodiments, these remote digital codes can be downloaded and stored in a storage device of the computer 40 in advance. Then, the universal remote controller 10 is coupled to the computer 40 for updating information data of these remote digital codes. Moreover, a new version of the operating interface of the universal remote controller 10 also can be downloaded by the computer 40 through the internet network 401, and the operating interface of the universal remote controller 10 can be updated by coupling to the computer to maintain the latest operating interface version. Then, the user can control various remote controllable electric devices in his house to follow his inclinations.

Except for coupling to a computer 40 through an internet network 401 to update the universal remote controller 10, in the other embodiment of the present invention, the universal remote controller 10 also can copy all buttons of a remote controller of a remote controllable electric device in the house. Regarding to FIG. 8B, take a television for example, a remote controller 510 with a television 50 in a user's house, and the user can let the universal remote controller 10 to search the frequency data of all buttons of the remote controller 510 and copy the frequency data then store in the storage module 103 of the universal remote controller 10. Thus, an exclusive operating interface of the television 50 can be used to remote control the television 50 depending on the frequency data copied from the remote controller 510 of the television 50. Although the example is only used a television for example, it's needed to understand all remote controllable electric devices can be used the above-mentioned method to remote control with copying all buttons of its original remote controller corresponding to an exclusive operating interface of the universal remote controller 10. Therefore, the universal remote controller 10 of the present invention could be used to control all remote controllable electric devices in a house.

In a still another embodiment according to the present invention, a user only needs to let the universal remote controller 10 aiming to a remote controllable electric device and executing auto-searching function to find the remote frequency of the remote controllable electric device. When the universal remote controller 10 finds the remote frequency data of the remote controllable electric device, the auto-searching function will stop. Then, the universal remote controller 10 will store the remote frequency data of the remote controllable electric device in the storage module 103, and the user can use the universal remote controller 10 to remote control the remote controllable electric device. Moreover, the user can use the universal remote controller 10 to search the remote frequency of another different remote controllable electric device after setting the remote frequency data of a remote controllable electric device. Therefore, all of the remote frequencies of remote controllable electric devices in a house can be set in the universal remote controller 10. Regarding to FIG. 8C, take a television for example, a user only needs to let the universal remote controller 10 aiming to a television 50 and executing auto-searching function to find the remote frequency of the television 50, then storing the remote frequency data of the television 50 in the storage module of the universal remote controller 10, such as a memory, after finding the remote frequency data of the television 50. Then, the user can use the universal remote controller 10 to control the television 50.

Furthermore, the universal remote controller 10 according to the present invention also can set and store the remote digital data of all remote controllable electric devices by using all above-mentioned methods. Some remote digital codes of remote controllable electric devices can be obtained easily, such as the remote controllable electric devices made by famous companies. Sometimes, these kinds of remote digital codes would be built in the universal remote controller 10. If those remote controllable electric devices are new products of those famous companies, the remote digital codes of those remote controllable electric devices are also easy to update through an internet network. However, the user also can use the universal remote controller 10 to copy all buttons of a remote controller of a remote controllable electric device if he can't find the remote digital codes of the remote controllable electric device, such as a remote controllable electric device made by a non-famous company, then he can store the all buttons' function in the storage module 103 of the universal remote controller 10. Moreover, the user also can let the universal remote controller 10 aiming to a remote controllable electric device and executing auto-searching function to find the remote frequency of the remote controllable electric device if the remote controller of the remote controllable electric device is lost. Therefore, the user can use the universal remote controller 10 according to the present invention to control any remote controllable electric device in his house.

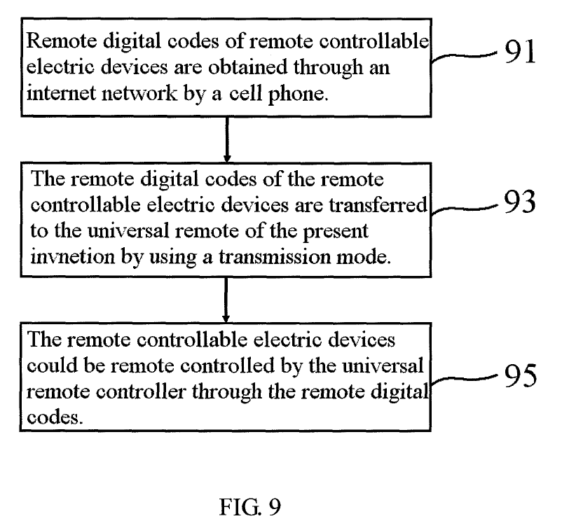

In addition to the above-mentioned methods for obtaining the remote digital codes of the remote controllable electric devices to the universal remote controller 10 of the present invention, the remote digital codes also can be obtained by a cell phone through an internet network in one embodiment of the present invention. Then, the remote digital codes are transferred to the universal remote controller 10 of the present invention by using a transmission mode such as Bluetooth. Regarding to FIG. 9, it shows a flow chart of a method for the universal remote controller of the present invention to obtain remote digital codes of a remote controllable electric device by a cell phone. First at all, the step 91 shows remote digital codes of remote controllable electric devices are obtained through an internet network by a cell phone. In this step, the cell phone can be used to connect a website of a manufacturer through an internet network for obtained the remote digital codes of the remote controllable electric devices by any traditional connecting way. Sequentially, the step 93 shows the remote digital codes of the remote controllable electric devices are transferred to the universal remote controller of the present invention by using a transmission mode. In this step, the transmission mode is built-in the cell phone, such as Bluetooth or Wi-Fi, for transferring the downloaded remote digital codes to the universal remote controller 10 through the signal transmission module 111. In another embodiment, an infrared transmitter is connected to the cell phone for transferring the downloaded remote digital codes to the universal remote controller 10 through the signal transmission module 111 by infrared transmission. Finally, the step 95 shows the remote controllable electric devices could be remote controlled by the universal remote controller through the remote digital codes. The remote digital codes are transferred to the universal remote controller 10 by the cell phone, and stored in the storage module 103 of the universal remote controller 10. Thus, a user can use the universal remote controller 10 to remote control the remote controllable electric device through the remote digital codes.

Otherwise, some exclusive operating interfaces stored in the universal remote controller 10 according to the present invention do not require for the user, and he can conceal or cannel those exclusive operating interfaces from the universal remote controller 10 for customizing. The user only needs to operate the finger control module 109 of the universal remote controller 10 to control the operating interface of the universal remote controller 10 to conceal or cannel those exclusive operating interfaces he doesn't require. Moreover, the operating interface of the universal remote controller 10 is designed as GUI, and a user can easy to understand the operating method of the universal remote controller 10. Furthermore, combining some actual shortcut buttons is more easily to operate the universal remote controller 10 for the user. Besides, the universal remote controller 10 only has few simply actual buttons for reducing the volume of the universal remote controller 10 to carry easily.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A universal remote controller, comprising:
a controlling and processing module to control and process said universal remote controller for operating;
a storage module coupled to said controlling and processing module for storing information data, wherein said information data comprises a plurality of remote digital codes of remote controllable electric devices;
a display module coupled to said controlling and processing module for displaying an operating interface of said universal remote controller;
a finger control module coupled to said controlling and processing module for inputting a first command to said controlling and processing module for controlling said universal remote controller;
a keypad module coupled to said controlling and processing module for inputting a second command to said controlling and processing module for controlling any one of said remote controllable electric device; and
a signal transmission module coupled to said controlling and processing module for receiving the first command and the second command from said controlling and processing module and emitting a controlling signal to control said remote controllable electric device.

2. The universal remote controller according to claim 1, wherein said finger control module comprises a joystick; and said joystick further comprises at least one set of joystick potentiometer for coupling to said controlling and processing module, wherein said at least one set of joystick potentiometer is utilized to detect an input position of said joystick and output two sets of voltages according to X-axis and Y-axis to said controlling and processing module, and said controlling and processing module via an analogy-to-digital converter to read said voltage and to confirm the position of said joystick.

3. The universal remote controller according to claim 1, wherein said operating interface comprises a graphic user interface (GUI), and said operating interface further comprises a plurality of exclusive operating interfaces corresponding to different remote controllable electric devices.

4. The universal remote controller according to claim 1, wherein said keypad module further comprises a set of actual input keypad.

5. The universal remote controller according to claim 1, wherein said display module further comprises a touch panel; and said operating interface further comprises a set of virtual input keypad.

6. The universal remote controller according to claim 1, further comprising a mini USB port to couple a computer for transferring information data, wherein said universal remote controller coupled to a power source for charging said battery.

7. The universal remote controller according to claim 6, wherein said universal remote controller coupled to said computer via said mini USB port for downloading update data of remote digital codes of said electric devices through an internet network.

8. The universal remote controller according to claim 1, wherein said universal remote controller copies all functions of buttons of a remote controller of said remote controllable electric device and storing said functions in said storage module.

9. The universal remote controller according to claim 1, wherein said universal remote controller aims to a remote controllable electric device and excludes auto-searching function to find remote frequency of said remote controllable electric device and stores in said storage module.

10. The universal remote controller according to claim 1, wherein said universal remote controller to control a center controlling system for controlling any remote controllable electric device.

11. A method of using a cell phone to obtain remote digital codes for the universal remote controller according to claim 1, comprising:
using a cell phone to obtain remote digital codes corresponding to at least one remote controllable electric device through an internet network;
transferring said remote digital codes to said universal remote controller by using a transmission mode; and
remote controlling said at least one remote controllable electric device by said universal remote controller through said remote digital codes.

12. The method according to claim 11, wherein said transmission mode comprises infrared transmission.

13. The method according to claim 11, wherein said transmission module comprises Bluetooth.
